(19) United States
(12) Patent Application Publication
(10) Pub. No.: US 2013/0180432 A1
(43) Pub. Date: Jul. 18, 2013

(54) COATING, A TURBINE COMPONENT, AND A PROCESS OF FABRICATING A TURBINE COMPONENT

(71) Applicants: Eklavya CALLA, Bangalore (IN); Warren Arthur NELSON, Clifton Park, NY (US); Paul Stephen DIMASCIO, Greer, SC (US); Krishnamurthy ANAND, Bangalore (IN); Sundar AMANCHERLA, Bangalore (IN); Maruthi MANCHIKANTI, Bangalore (IN)

(72) Inventors: Eklavya CALLA, Bangalore (IN); Warren Arthur NELSON, Clifton Park, NY (US); Paul Stephen DIMASCIO, Greer, SC (US); Krishnamurthy ANAND, Bangalore (IN); Sundar AMANCHERLA, Bangalore (IN); Maruthi MANCHIKANTI, Bangalore (IN)

(73) Assignee: GENERAL ELECTRIC COMPANY, Schenectady, NY (US)

(21) Appl. No.: 13/352,562

(22) Filed: Jan. 18, 2012

(51) Int. Cl. C09D 1/00

(52) U.S. Cl. 106/286.3; 106/286.1; 106/286.4; 106/286.5

(57) ABSTRACT

Disclosed is a coating, a turbine component, and a process of fabricating a turbine component. The coating includes a ceramic phase formed by ceramic particles and a ductile matrix having a ductility greater than the ceramic phase. The ceramic phase includes substantially the same microstructure as the ceramic particles. The turbine component includes a surface having the coating. The process includes applying the coating to the surface of the turbine component.

### FIELD OF THE INVENTION

The present invention is directed to manufactured articles and processes. More specifically, the present invention is directed to coatings, turbine components, and processes of fabricating turbine components.

### BACKGROUND OF THE INVENTION

Many systems, such as those in gas turbines, are subjected to thermally, mechanically and chemically hostile environments. For example, in the compressor portion of a gas turbine, atmospheric air is compressed to 10-25 times atmospheric pressure, and adiabatically heated to about 800° F. to about 1250° F. in the process. This heated and compressed air is directed into a combustor, where it is mixed with fuel. The fuel is ignited, and the combustion process heats the gases to very high temperatures, in excess of about 3000° F. These hot gases pass through the turbine, where airfoils fixed to rotating turbine disks extract energy to drive the fan and compressor of the turbine, and the exhaust system, where the gases provide sufficient energy to rotate a generator rotor to produce electricity. Tight seals and precisely directed flow of the hot gases provide operational efficiency. To achieve such tight seals in turbine seals and precisely directed flow can be difficult to manufacture and expensive.

To improve the efficiency of operation of turbines, combustion temperatures have been raised and are continuing to be raised. To withstand these increased temperatures, a high alloy honeycomb section brazed to a stationary structure has been used. The high alloy honeycomb can be expensive in material costs, and brazing it to the stationary structure can be expensive.

Other porous, foam, and/or honeycomb components, such as those serving as abradable rub coats, similarly can be expensive or have operational limits. For example, such materials can oxidize or change phase during application of the materials and/or processing of the materials. Welding or brazing of such materials can adversely affect the microstructure and/or mechanical properties of the component. For example, welding or brazing can form a heat affected zone that results in debit of mechanical properties.

A coating, a turbine component, and a process of fabricating turbine components that do not suffer from one or more of the above drawbacks would be desirable in the art.

### BRIEF DESCRIPTION OF THE INVENTION

In an exemplary embodiment, a coating includes a ceramic phase formed by ceramic particles and a ductile matrix having a ductility greater than the ceramic phase. The ceramic phase includes substantially the same microstructure as the ceramic particles.

In another exemplary embodiment, a turbine component includes a surface having a coating. The coating includes a ceramic phase formed by ceramic particles and a ductile matrix having a ductility greater than the ceramic phase. The ceramic phase includes substantially the same microstructure as the ceramic particles.

In another exemplary embodiment, a process of fabricating a turbine component includes applying a coating to a surface of the turbine component. The coating includes a ceramic phase formed by ceramic particles and a ductile matrix having a ductility greater than the ceramic phase.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows an exemplary seal arrangement having one layer positioned between a shroud and a blade according to the disclosure.

FIG. 2 shows an exemplary seal arrangement having multiple layers positioned between a shroud and a blade according to the disclosure.

FIG. 3 shows a flow diagram of an exemplary process of applying a metallic porous structure according to the disclosure.

FIG. 4 shows a schematic view of an apparatus for forming an exemplary article having a metallic porous structure applied according to an exemplary process of the disclosure.

FIG. 5 shows a schematic view of an apparatus for forming an exemplary article having a metallic porous structure applied according to an exemplary process of the disclosure.

Wherever possible, the same reference numbers will be used throughout the drawings to represent the same parts.

### DETAILED DESCRIPTION OF THE INVENTION

Provided is an exemplary coating, a turbine component and a process of fabricating a turbine component according to the disclosure. Embodiments of the present disclosure permit operation of components over a greater range of temperatures, permit tighter tolerances between rotating components and stationary components, increase wear resistance, reduce or eliminate the formation of decarburized particles, reduce or eliminate the formation of brittle phases, increase adhesion, reduce or eliminate oxidation of components, extend operational life of components, permit formation of coatings using a reduced amount of heat or no added heat, or combinations thereof.

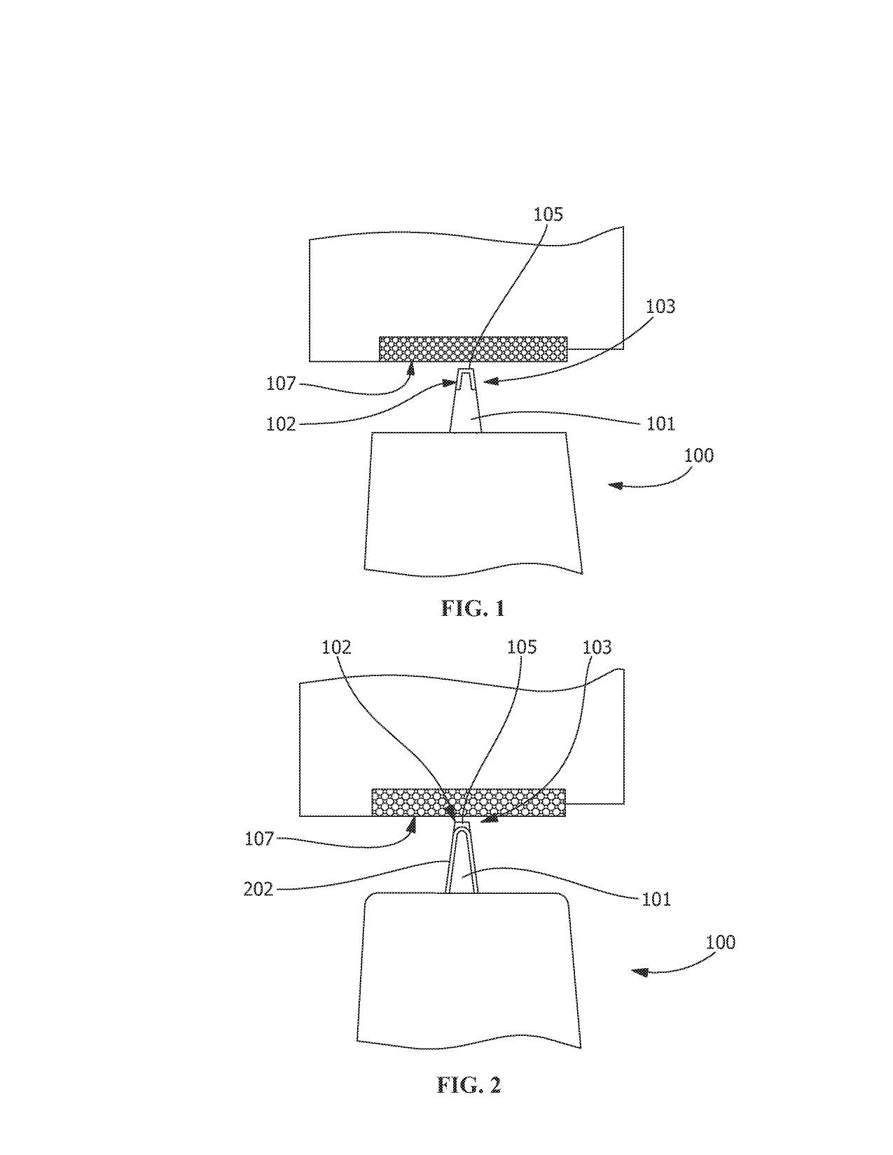

FIGS. 1 and 2 show exemplary articles 100, such as, a turbine blade, having a coated portion 102, such as a blade tip 103. The coated portion 102 is positioned directly on a substrate 101 of the article 100 as shown in FIG. 1 or is positioned on one or more intermediate layers 202 on the substrate 101 as shown in FIG. 2.

The article 100 is any suitable metallic component, such as a stationary component or a rotating part. Suitable metallic components include, but are not limited to, compressor components, turbine components, turbine blades, and turbine buckets. In one embodiment, the turbine component is a hot section component. In one embodiment, the turbine component is a cold section component. The coated portion 102 is any suitable portion or surface of the article 100. In one embodiment, the coated portion 102 is a portion of the article 100, such as, the blade tip 103, a leading edge of a blade, a trailing edge of a blade, a pressure side of a blade, a suction side of a blade, a bucket, or a combination thereof.

The coated portion 102 is or includes a coating 105 having a ceramic phase formed by ceramic particles and a ductile matrix formed by a metallic material. As used herein, the term “metallic” is intended to encompass metals, alloys, composite metals, intermetallic materials, or any combination thereof. The ductile matrix has a ductility greater than the ceramic phase. According to one embodiment, application of the coating 105 results in little or no phase change to the ceramic particles and/or the metallic material forming the ductile matrix. The coating 105 permits tighter clearances at steady-state conditions between the coated portion 102 and other surfaces 107 and/or is capable of being applied on other surfaces, such as, on a turbine seal, a fillet, a compressor seal, a labyrinth seal, a brush seal, a flexible seal, a damping mechanism, a cooling mechanism, bucket interiors, pistons, heat exchangers, a shroud, a stator component, a rotor component, or combinations thereof.

The combination of the ceramic phase and the ductile matrix provides wear protection. The ceramic phase is formed by ceramic particles. Suitable ceramic particles include, but are not limited to, tungsten carbide, chromium carbide, zirconia, hafnium oxide, alumina, mullite, sialon, and combinations thereof.

The ductile matrix includes material with a greater ductility than the ceramic phase. In one embodiment, the ductile matrix includes stainless steel, for example, a steel alloy composition having, by weight, greater than about 10.5% chromium. In one embodiment, the ductile matrix includes a MCrAlY alloy, where M is nickel, cobalt, iron, alloys thereof, and combinations thereof. In one embodiment, the ductile matrix includes a nickel-based alloy and/or a cobalt-based alloy.

In one embodiment, the ductile matrix includes a composition having, by weight, between about 20.0% and about 23.0% chromium, up to about 5.0% iron, between about 8.0% and about 10.0% molybdenum, between about 3.2% and about 4.2% niobium, up to about 1.0% cobalt, up to about 0.5% manganese, up to about 0.4% aluminum, up to about 0.4% titanium, up to about 0.5% silicon, up to about 0.1% carbon, up to about 0.015% sulfur, up to about 0.015% phosphorus, incidental impurities, and a balance nickel (for example, up to about 58.0%).

In one embodiment, the ductile matrix includes a composition having, by weight, up to about 0.06% carbon, up to about 0.35% manganese, up to about 0.35% silicon, up to about 0.020% phosphorus, up to about 0.015% sulfur, between about 14.5% and about 17.5% chromium, up to about 1.00% cobalt, up to about 0.40% aluminum, between about 1.50% and about 2.00% titanium, up to about 0.006% boron, up to about 0.30% copper, between about 39.0% and about 44.0% nickel and cobalt, between about 2.50% and about 3.30% columbium and tantalum, incidental impurities, and a balance iron.

In one embodiment, the ductile matrix includes a composition having, by weight, between about 50.0% and about 55.0% nickel, between about 17.0% and about 21.0% chromium, between about 2.8% and about 3.3% molybdenum, between about 4.75% and about 5.5% niobium, up to about 1.0% cobalt, up to about 0.35% manganese, between about 0.65% and about 1.15% aluminum, up to about 0.3% titanium, up to about 0.35% silicon, up to about 0.08% carbon, up to about 0.015% sulfur, up to about 0.015% phosphorus, up to about 0.006% boron, incidental impurities, and a balance iron.

In one embodiment, the ductile matrix includes a composition having, by weight, between about 55% and about 59% nickel, between about 19% and about 22.5% chromium, between about 7% and about 9.5% molybdenum, up to about 0.35% aluminum, between about 1% and about 1.7% titanium, between about 2.75% and about 4% niobium, incidental impurities, and a balance iron.

In one embodiment, the ductile matrix includes a composition having, by weight, between about 20.5% and about 23.0% chromium, between about 8.00% and about 10.0% molybdenum, up to about 1.00 manganese, between about 0.05% and about 0.15% carbon, up to about 1.00% silicon, between about 17.0% and about 20.0% iron, incidental impurities, and a balance nickel.

In one embodiment, the ductile matrix includes a composition having, by weight, between about 0.05% and about 0.09% carbon, between about 14.0% and about 15.25% chromium, between about 14.25% and about 15.75% cobalt, between about 3.9% and about 4.5% molybdenum, between about 3.0% and about 3.7% titanium, between about 4.0% and about 4.6% aluminum, incidental impurities, and a balance nickel.

In one embodiment, the ductile matrix includes a composition having, by weight, up to about 7.5% cobalt, up to about 7.0% chromium, up to about 6.5% tantalum, up to about 6.2% aluminum, up to about 5.0% tungsten, up to about 3.0% rhenium, up to about 1.5% molybdenum, up to about 0.15% hafnium, up to about 0.05% carbon, up to about 0.004% boron, up to about 0.01% yttrium, and a balance of nickel.

In one embodiment, the ductile matrix includes a composition having, by weight, between about 26% and about 30.0%, between about 4.0% and about 6.0% nickel, up to about 0.5%, between about 18.0% and about 21.0% tungsten and molybdenum, between about 0.75% and about 1.25% vanadium, between about 0.005% and about 0.1% boron, between about 0.7% and about 1.0% carbon, up to about 3.0% iron, up to about 1.0% manganese, up to about 1.0% silicon, incidental impurities, and a balance cobalt.

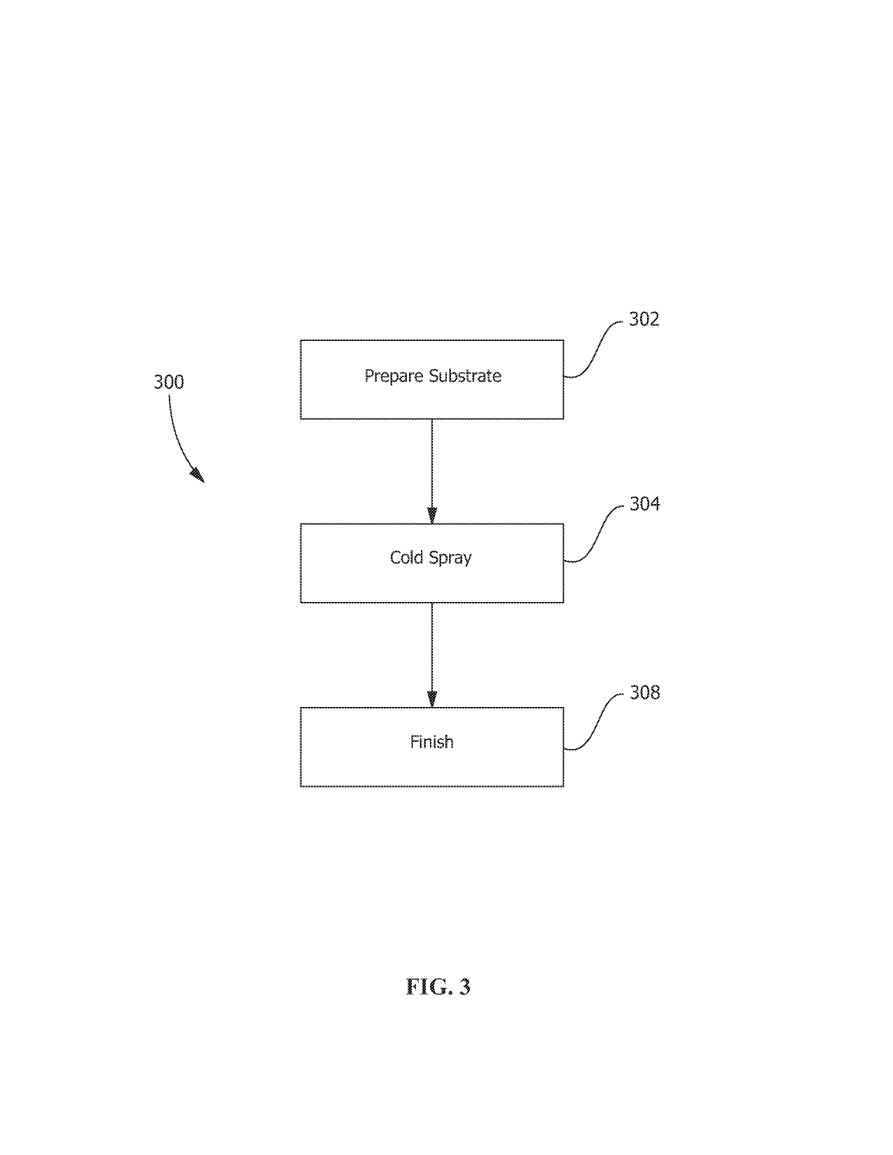

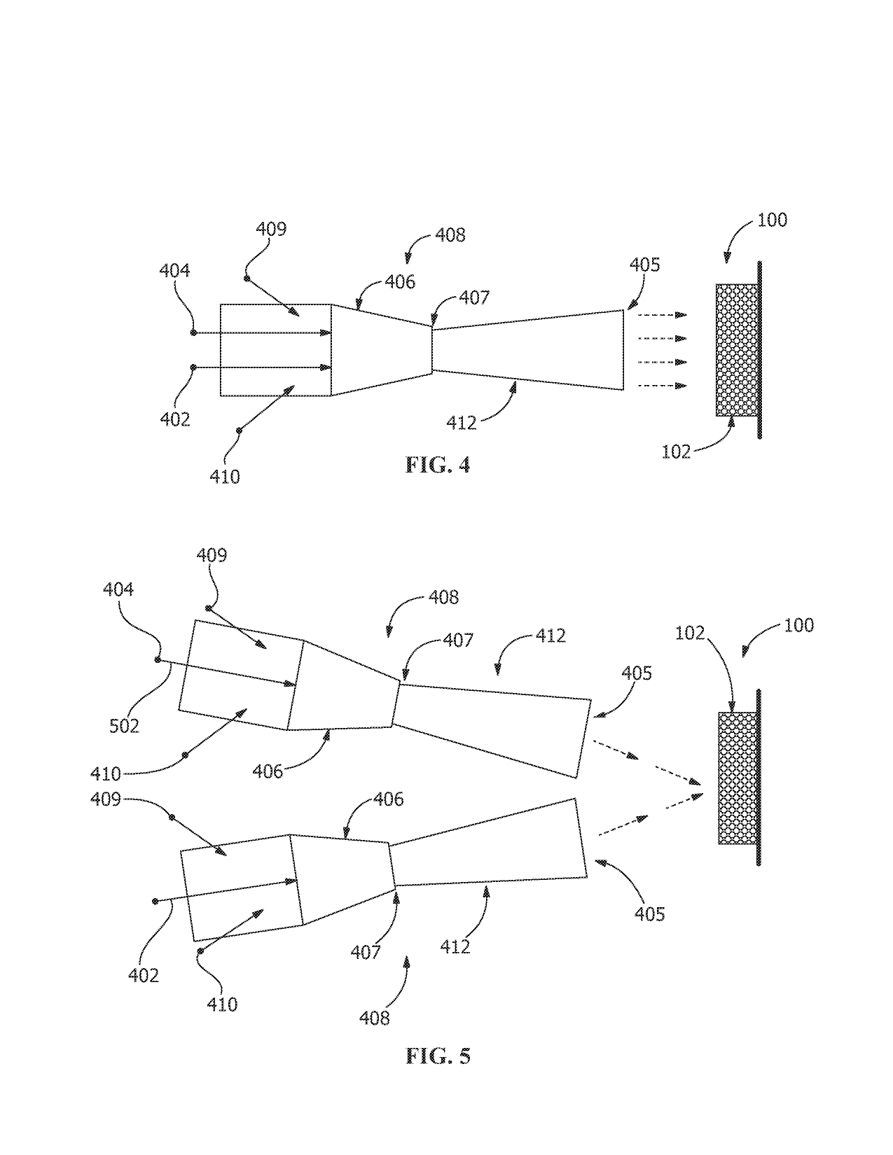

In one embodiment, the coating 105 on the coated portion 102 of the article 100 is applied by cold spray. In comparison to techniques like plasma spraying or high-velocity oxy-fuel spraying, applying the coating 105 by cold spray reduces or eliminates oxidation during spraying, increases fatigue resistance (for example, by providing compressive stresses during the process), increases adhesion, or combinations thereof. Referring to FIG. 3, in an exemplary process 300 of applying the coating 105, the article 100 is prepared (step 302), for example, by cleaning the surface of the article 100. The coated portion 102 is then applied to the article 100 by cold spray (step 304). The cold spraying (step 304) uses a solid/powder feedstock 402 (see FIGS. 4 and 5) and the processing takes place mostly in a solid condition with less heat than processes such as welding or brazing, resulting in little or no heat-related changes in microstructure and/or properties of the substrate 101 of the article 100.

In one embodiment, the solid feedstock 402 includes the ceramic particles and the materials of the ductile matrix. In another embodiment, the solid feedstock 402 includes the ceramic particles or the materials of the ductile matrix. The solid feedstock 402 has a fine grain size, for example, below about 105 microns, below about 50 microns, below about 25 microns, below about 15 microns, between about 10 and about 105 microns, between about 10 and about 25 microns, between about 10 and about 15 microns, or any suitable combination or sub-combination thereof. In one embodiment, the solid feedstock 402 has a combination of particle sizes. For example, in one embodiment, a first portion of the ceramic particles in the solid feedstock 402 are at a first grain size and a second portion of the ceramic particles in the solid feedstock 402 are at a second grain size differing from the first grain size. Additionally or alternatively, in one embodiment, the solid feedstock 402 includes the materials of the ductile matrix at a combination of particle sizes. For example, in one embodiment, a first portion of the materials of the ductile matrix in the solid feedstock 402 are at a first grain size and a second portion of the materials of the ductile matrix in the solid feedstock 402 are at a second grain size, differing from the first grain size. The combination of particle sizes permits unique microstructures, further adjustability during the cold spraying (step 304), and/or increase wear resistance. For example, larger particles tend to protect against impact better than smaller particles. However, larger particles can become detached from the coating 105 easier than smaller particles. Combining larger and smaller particles provides a balance between impact protection and resistance to becoming detached.

The cold spraying (step 304) forms the coating 105 by impacting the solid feedstock 402 particles in the absence of significant heat input to the solid feedstock 402. The cold spraying (step 304) substantially retains the phases and microstructure of the solid feedstock 402 and provides little or no heat to the substrate 101 of the article 100. In one embodiment, the cold spraying (step 304) continues until the coating 105 is within a desired thickness range or slightly above the desired thickness range (to permit finishing), for example, between about 1 mil and about 2000 mils, between about 1 mil and about 100 mils, between about 5 mils and about 20 mils, between about 10 mils and about 30 mils, between about 10 mils and about 20 mils, between about 10 mils and about 50 mils, between about 10 mils and about 15 mils, or any suitable combination or sub-combination thereof.

In one embodiment, the cold spraying (step 304) includes accelerating the solid feedstock 402 to at least a predetermined velocity or velocity range, for example, based upon the below equation for a converging-diverging nozzle 408 as is shown in FIG. 4:

$$\frac{A}{{A}^{*}} = {\frac{1}{M} [ \frac{2}{γ + 1} ] [ 1 + ( \frac{γ - 1}{2} ) {M}^{2} ]}^{\frac{γ + 1}{2 ( γ - 1 )}} \qquad ( Equation 1 )$$

In Equation 1, “A” is the area of nozzle exit 405 and “A*” is the area of nozzle throat 407. “γ” is the ratio Cₚ/Cᵥ of a process gas 409 being used (Cₚ being the specific heat capacity at constant pressure and Cᵥ being the specific heat capacity at constant volume). The gas flow parameters depend upon the ratio of A/A*. When the nozzle 408 operates in a choked condition, the exit gas velocity Mach number (M) is identifiable by the equation 1. Gas having higher value for “γ” results in a higher Mach number. The parameters are measured/monitored by sensors 410 positioned prior to the converging portion 406. The solid feedstock 402 impacts the article 100 at the predetermined velocity or velocity range and the solid feedstock 402 bonds to the article 100 to form the coated portion 102.

The nozzle 408 is positioned a predetermined distance from the article 100, for example, between about 10 mm and about 150 mm, between about 10 mm and about 50 mm, between about 50 mm and about 100 mm, between about 10 mm and about 30 mm, between about 30 mm and about 70 mm, between about 70 mm and about 100 mm, or any suitable combination or sub-combination thereof.

In one embodiment, the cold spraying (step 304) includes impacting the solid feedstock 402 in conjunction with a separate feedstock 502 (see FIG. 5), for example, including an identical material or a different material, and applied by a separate nozzle 408. In one embodiment, the ceramic particles are in the solid feedstock 402 and the materials of the ductile matrix are in the separate feedstock 502. Likewise, in one embodiment, the materials of the ductile matrix are in the solid feedstock 402 and the ceramic particles are in the separate feedstock 502. In embodiments with the solid feedstock 402 and the separate feedstock 502 having different compositions, the composition of the coating 105 is capable of being adjusted by adjusting operational parameters of the cold spraying (step 304).

Referring to FIG. 5, in one embodiment, the cold spraying (step 304) includes accelerating the solid feedstock 402 and/or the separate feedstock 502 to at least a predetermined velocity or velocity range, for example, based upon the equation 1. In one embodiment, the cold spraying (step 304) corresponding to FIG. 5 involves nozzles 408 designed with a combined A/A* ratio to suit spraying a particular material (either a ceramic particle and/or material of the ductile matrix). In a further embodiment, the cold spraying (step 304) uses different gases in different nozzles 408 and/or includes relative adjustment of other parameters. In one embodiment, multiple nozzles 408 are used to handle incompatibility associated with feedstock having a metallic phase and feedstock having a ceramic phase.

As shown in FIG. 3, in one embodiment, the process 300 includes finishing (step 308) the coated portion 102 and/or the article 100, for example, by grinding, machining, shot peening, or otherwise processing.

Referring to FIG. 2, in one embodiment, the coated portion 102 is positioned on one or more of the intermediate layers 202. In one embodiment, at least one of the intermediate layers 202 is a bond coat. The bond coat is applied to the substrate 101 or one or more additional bond coats on the substrate 101, for example, by cold spray. In one embodiment, the bond coat is a ductile material, such as, for example, Ti₆Al₄V, Ni—Al, nickel-based alloys, cobalt-based alloys, stainless steels, ferrous alloys, carbon steel, aluminum, titanium, or other suitable materials. The bond coat is applied at a predetermined thickness, for example, between about 2 mils and about 15 mils, between about 2 mils and about 5 mils, between about 5 mils and about 10 mils, between about 10 mils and about 15 mils, between about 2 mils and about 3.0 mils, greater than about 1 mil, greater than about 2 mils, or any suitable combination or sub-combination thereof.

In another embodiment, the coating 105 is applied by high-velocity oxy fuel spraying, high velocity air fuel spraying, and/or air plasma spraying. In these embodiments, the ceramic particles in the coating 105 decrease hard phase characteristics through the spraying process. The decrease in hard phase characteristics for the air plasma spraying is the least. The decrease in hard phase characteristics for the high-velocity oxy fuel spraying is greater and the high-velocity air fuel spraying is the greatest. To compensate for the decrease in hard phase characteristics, in one embodiment, the amount of the ceramic particles applied in the coating 105 is adjusted. For example, in one embodiment, the density of the ceramic particles in the coating 105 is greater to correspond with the ceramic particles having a greater decrease in hard phase characteristics.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A coating, comprising:
a ceramic phase formed by ceramic particles; and
a ductile matrix having a ductility greater than the ceramic phase;
wherein the ceramic phase includes substantially the same microstructure as the ceramic particles.

2. The coating of claim 1, wherein the ceramic particles are selected from the group consisting of tungsten carbide, chromium carbide, zirconia, hafnium oxide, alumina, mullite, sialon, and combinations thereof.

3. The coating of claim 1, wherein the ceramic particles include tungsten carbide and the ceramic phase is substantially devoid of ditungsten carbide.

4. The coating of claim 1, wherein the ceramic phase is substantially devoid of decarburized ceramics.

5. The coating of claim 1, wherein the ceramic phase is substantially devoid of oxidized ceramics.

6. The coating of claim 1, wherein the ductile matrix includes stainless steel.

7. The coating of claim 1, wherein the ductile matrix includes a MCrAlY alloy.

8. The coating of claim 1, wherein the ductile matrix includes one or both of a nickel-based alloy and a cobalt-based alloy.

9. The coating of claim 1, wherein the ductile matrix includes a composition, by weight, of between about 20.0% and about 23.0% chromium, up to about 5.0% iron, between about 8.0% and about 10.0% molybdenum, between about 3.2% and about 4.2% niobium, up to about 1.0% cobalt, up to about 0.5% manganese, up to about 0.4% aluminum, up to about 0.4% titanium, up to about 0.5% silicon, up to about 0.1% carbon, up to about 0.015% sulfur, up to about 0.015% phosphorus, incidental impurities, and a balance nickel (for example, up to about 58.0%).

10. The coating of claim 1, wherein the ductile matrix includes a composition, by weight, of up to about 0.06% carbon, up to about 0.35% manganese, up to about 0.35% silicon, up to about 0.020% phosphorus, up to about 0.015% sulfur, between about 14.5% and about 17.5% chromium, up to about 1.00% cobalt, up to about 0.40% aluminum, between about 1.50% and about 2.00% titanium, up to about 0.006% boron, up to about 0.30% copper, between about 39.0% and about 44.0% nickel and cobalt, between about 2.50% and about 3.30% columbium and tantalum, incidental impurities, and a balance iron.

11. The coating of claim 1, wherein the ductile matrix includes a composition, by weight, of between about 50.0% and about 55.0% nickel, between about 17.0% and about 21.0% chromium, between about 2.8% and about 3.3% molybdenum, between about 4.75% and about 5.5% niobium, up to about 1.0% cobalt, up to about 0.35% manganese, between about 0.65% and about 1.15% aluminum, up to about 0.3% titanium, up to about 0.35% silicon, up to about 0.08% carbon, up to about 0.015% sulfur, up to about 0.015% phosphorus, up to about 0.006% boron, incidental impurities, and a balance iron.

12. The coating of claim 1, wherein the ductile matrix includes a composition, by weight, of between about 55% and about 59% nickel, between about 19% and about 22.5% chromium, between about 7% and about 9.5% molybdenum, up to about 0.35% aluminum, between about 1% and about 1.7% titanium, between about 2.75% and about 4% niobium, incidental impurities, and a balance iron.

13. The coating of claim 1, wherein the ductile matrix includes a composition, by weight, of between about 20.5% and about 23.0% chromium, between about 8.00% and about 10.0% molybdenum, up to about 1.00 manganese, between about 0.05% and about 0.15% carbon, up to about 1.00% silicon, between about 17.0% and about 20.0% iron, incidental impurities, and a balance nickel.

14. The coating of claim 1, wherein the ductile matrix includes a composition, by weight, of between about 0.05% and about 0.09% carbon, between about 14.0% and about 15.25% chromium, between about 14.25% and about 15.75% cobalt, between about 3.9% and about 4.5% molybdenum, between about 3.0% and about 3.7% titanium, between about 4.0% and about 4.6% aluminum, incidental impurities, and a balance nickel.

15. The coating of claim 1, wherein the ductile matrix includes a composition, by weight, of up to about 7.5% cobalt, up to about 7.0% chromium, up to about 6.5% tantalum, up to about 6.2% aluminum, up to about 5.0% tungsten, up to about 3.0% rhenium, up to about 1.5% molybdenum, up to about 0.15% hafnium, up to about 0.05% carbon, up to about 0.004% boron, up to about 0.01% yttrium, and a balance of nickel.

16. The coating of claim 1, wherein the ductile matrix includes a composition, by weight, of between about 26% and about 30.0% chromium, between about 4.0% and about 6.0% nickel, between about 18.0% and about 21.0% tungsten and molybdenum, between about 0.75% and about 1.25% vanadium, between about 0.005% and about 0.1% boron, between about 0.7% and about 1.0% carbon, up to about 3.0% iron, up to about 1.0% manganese, up to about 1.0% silicon, incidental impurities, and a balance cobalt.

17. The coating of claim 1, wherein the coating is a cold-sprayed coating.

18. The coating of claim 1, wherein the coating is positioned on a surface of a turbine component selected from the group consisting of a blade tip, a blade leading edge, a blade trailing edge, a blade pressure side, a blade suction side, a bucket, and combinations thereof.

19. A turbine component, comprising:
a surface having a coating, the coating comprising:
a ceramic phase formed by ceramic particles; and
a ductile matrix having a ductility greater than the ceramic phase;
wherein the ceramic phase includes substantially the same microstructure as the ceramic particles.

20. A process of fabricating a turbine component, the process comprising:
applying a coating to a surface of the turbine component, the coating comprising:
a ceramic phase formed by ceramic particles; and
a ductile matrix having a ductility greater than the ceramic phase.
